(19) United States
(12) Patent Application Publication
(10) Pub. No.: US 2017/0102857 A1
(43) Pub. Date: Apr. 13, 2017

(54) Multimedia View With Dynamic Resizing and Scaling Upon User Interaction or Non-Human Event Triggers

(71) Applicant: Raghav Badiger, Columbia, SC (US)

(72) Inventor: Raghav Badiger, Columbia, SC (US)

(21) Appl. No.: 15/285,920

(22) Filed: Oct. 5, 2016

Related U.S. Application Data
(60) Provisional application No. 62/239,532, filed on Oct. 9, 2015.

(51) Int. Cl. G06F 3/0484; G06F 3/0488; G06F 3/0482

(52) U.S. Cl. CPC G06F 3/04845; G06F 3/0482; G06F 3/04847; G06F 3/04883

(57) ABSTRACT

A multiple video viewer with dynamic resizing and scaling upon user interaction or other applicable automated non-human event triggers. The invention provides the ability for a user to focus on any one or more video feeds by dynamically resizing the video windows. When in ‘Play’ mode all the videos are still playing and scale dynamically as required by user interaction. Since they are synchronized in time the user will be able to view other videos by moving the controls back and forth in the timeline and focusing on other views.

### CLAIM TO PRIORITY

This Non-Provisional application claims under 35 U.S.C. §120, the benefit of the Provisional Application 62/239,532, filed Oct. 7, 2015, Titled “MULTIPLE VIDEO VIEWER WITH DYNAMIC RESIZING AND SCALING UPON USER INTERACTION OR NON-HUMAN EVENT TRIGGERS”, which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Video displays upon many devices permit a user to view multiple videos simultaneously on such devices. In many implementations when a second video display is called for by a user, the video is unlikely to be linked with the pre-existing video on display. The subsequent video display may also be presented in a format that overlaps or covers the first video display, making it difficult to view multiple video displays on a single screen without careful resizing and control actions by the user.

Additionally, commonly each video that is on display on a video screen has a separate control mechanism that makes controlling multiple videos on a single display a difficult task. Each video replay must be controlled separately by the user, meaning that the user must move from one window to another to make a control decision and perform a control action. This lack of synchronization may cause a user to miss details in one video window while attempting to control another video window.

Multiple display windows are possible on mobile devices; however the controls for such multiple displays are always separate and separately controllable.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a screen displaying four video feeds in four windows consistent with certain embodiments of the present invention.

FIG. 2 is a view of a user interface showing a resizing of the four windows and their respective video feeds consistent with certain embodiments of the present invention.

FIG. 3 is a view of a user interface showing a resizing of the four windows and their respective video feeds consistent with certain embodiments of the present invention.

FIG. 4 is a view of a screen displaying four video feeds in four windows consistent with certain embodiments of the present invention.

FIG. 5 is a view of user interface showing a flip-screen feature consistent with certain embodiments of the present invention.

FIG. 6 is a flow diagram for process of resizing and scaling of multiple screens upon resizing triggers consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The present invention relates to video display applications and more particularly to multi-view video applications for presentation of display windows on a single screen associated with a device. Current multi-view video applications, with all the videos and audio playing simultaneously, are distracting for the users to view and consume or analyze the content presented. Similarly, existing multi-view video players do not offer dynamic resizing/scaling and configuring of multiple non-overlapping videos by user interaction where the control of one or more video replays may be performed without impacting the replay of video in additional window views. Additionally, providing re-sizing of non-overlapping windows in a video display permits a user to emphasize those portions of a multiple view display without losing the context of the video that is presented in the display windows.

As can be seen, there is a need for a system and method that provides the ability for user to focus on any one or more videos by dynamically resizing the video windows. The dynamic resizing of the video windows may be associated with the synchronization between each window that continues to operate as the windows are resized, permitting the user to switch from view to view, and resizing windows as necessary, while permitting the view to remain consistent in time. The views presented in the synchronized windows may also be positionally shifted so as to present video views in varying orientations, which may permit a user to scrutinize the view in the altered orientation to discover additional details from the view.

In an embodiment, the present invention provides a user interface and a media player for computers, smartphones, tablets, wearable computing devices, and other network capable devices integrated with or connected to various electronic display technologies. The invention provides a user the ability to focus on any one or more videos by dynamically resizing the video windows. When in ‘Play’ mode all the videos are playing and through a user interface activated by one or more input methods such as mouse, keyboard, gesture on touch screens or motion gestures according to aspects of the invention. The user may make adjustments of the scale dynamically based upon user interaction and requirements for observation of details. The video content may be synchronized in time (absolute or relative), permitting the user to view all videos presented in active windows on the display screen by moving the controls back and forth in the timeline and focusing on views in the other windows. The present invention may also provide a media player for computers, smartphones, tablets, wearable computing devices, and other network capable devices integrated with or connected to electronic display technologies through hardware media encoders operable to convert and transmit live video streams to such players.

According to an embodiment of the invention, a representative system includes a computing device such as a personal computer, laptop computer, smartphone, tablet, wearable computing technology, or other network capable device, having a central processing unit (CPU), and, optionally, a graphical processing unit (GPU). The system may further include an electronic display device for the presentation of video and audio representations of multimedia information such as a monitor, a touchscreen, or other video display device. In certain aspects of the present invention, the computing device, inputs and output are connected to work as a system for information processing, human interaction and use. Upon activation by a user, the system control software may be operable to present an output and display of two or more media files, such as videos or other graphical content. The output may be provided with or without audio, as per the media file content presented in a given window. The display is preferably presented to the user in non-overlapping windows, while simultaneously playing all the selected available videos, presenting one display view or aspect of a common video presentation in each individual window. As indicated, the playback may also include accompanying audio associated with the video, if any is present in the multimedia presentation information file. Additionally, multimedia input may consist of video, audio, and multimedia content that may be pre-recorded or live-streamed, locally or remotely from other servers or devices through one or more wired or wireless communication channels.

In an embodiment of the invention a user interface may be provided that permits the user to dynamically, i.e., while the audio and video are playing and being presented to a user, resize or reconfigure the physical sizes of the windows in the screen display using one or more input devices or systems. Similarly, the user may continue to review the audio and video content by using one or more playback controllers provided by the user interface, such as play, pause, stop, rewind or forward, player speed and other controls.

The system reads and translates the input controls and gestures to resize and scale the video display windows in response to the input controls and gestures without interrupting the mode (play or pause) in which the videos or other content are playing at that point in time. The system transforms the media files (video files with or without audio) in such a way that they are broken down into corresponding sized or dimensioned “units” in relation to a time similar to ‘frames per second’.

In an embodiment, the invention provides that each input file, which may consist of video, audio, or multimedia content, is selected to be assigned for display to one of a plurality of windows. The system cycles through visible frames of each file and presents them to their respective windows for display, such that each may be displayed at synchronized corresponding points in time.

In an embodiment, aspects of the invention permit the user, at any point during the play of video, to indicate by a control selection to reconfigure the display layout by interacting with mouse, gesture, or other input device. In a non-limiting example, the user can drag the borders or intersection of borders to present a custom layout where one window display may be sized to play in a larger percentage of the display screen on the device than the other window displays operable at the same moment in time. When the windows are resized dynamically the software computes the relative sizes of windows and dynamically scales the video display for each window in response to the user control indication. Due to the power of CPU and, optionally, GPU combined with the size of units the human eye cannot perceive the rapid change in videos being altered and displayed. The transitions seem smooth and seamless to the user. In other aspects of the invention, the user may select to view the multimedia content in a non-overlap mode or a full-screen mode, where a single display window may be sized to occupy 100% of the display screen area of the device, which is the full-screen mode. However, although one display window may be sized to display in full-screen mode, the additional video views continue to be tracked in time such that if the user requests the multiple view, non-overlap mode for display of all views each display remains synchronized to the same corresponding portion of the video or multimedia presentation to maintain the integrity of the timeline for the display in each window.

In full-screen mode one video is played in an entire playing area, again where a single display window may be sized to occupy 100% of the display screen area of the device. User interaction or gesture to move the window left or right, up or down may be interpreted by the control software as a command to display another window display to the user. Due to the continuation of tracking during playback, a user may swipe the image on the display in full-screen mode to the left or to the right to view all additional views of the multimedia content being played. As the viewer scrolls to the left or right, a different view selected from the pre-configured number of display windows will replace the current view, still at 100% of the screen display area, and rotate the views in the display windows. Each view remains synchronized at the same playback point in the multimedia content, regardless of the speed of playback.

The integrity of the timeline is maintained when this transition is made. The multimedia content in a second window view may start playing from the same point in the timeline where the first window view stopped. The user may cycle through each video continuously this way through each of the window displays while maintaining the integrity of the timeline and remaining in full-screen mode in reviewing the video or multimedia data being presented. To exit the full-screen mode the user may tap on the display screen, and the original display with the pre-configured number of display windows will replace the full-screen view of a single display window.

In an embodiment of the invention, the user is provided player controls such as play, pause, and resume that apply the controls to all videos and audio at any given instant. In other embodiments a user can also interact individually with each video window via controls such a play or pause/stop and other control modes. In a non-limiting example, the user interface may provide the user the ability to flip the video about a vertical axis in one of the windows, to permit the user to review the video in the particular video window from another aspect or point of view. In other aspects, it may be desirable for the user to flip all window displays.

If available, users may switch to different audio files (for example, different music or language) at any time during any video review session. Audio may accompany one or more of the media content files or independent audio files may be provided as additional options for playback. According to a method of the present invention, once the user activates the system, the user chooses one or more sources of media files to be played. The video or multimedia file source can be stored files on the computing device, or the file source may be streamed from another connected, wired or wireless, remote device or system.

In an embodiment, videos may be presented on the display based on the number of source files chosen for display. In a non-limiting example, if two video files and an audio file are available for replay, then the video player area may be divided into two windows. If there are four video files available for display, then the display may be divided into four windows. The user may choose a media file source containing or delivering one or more videos, and with or without an associated audio file. The default display view may be equally sized windows, or may be sized based upon user defined default configuration parameters. After the default playback is initiated, the user may interact with one or more input devices to resize or reconfigure the displayed windows to a desired size and configuration.

The system and method of the present invention are best appreciated when it may be necessary or desirable to present and display two or more video files concurrently, although a single video is acceptable to the software. According to other aspects of the invention, various input controls other than standard ones (keyboard, mouse) are viable to work as input control. Motion gestures, motions, audio or audio signals, digitized analog elements such as temperature or light, or brain waves may control one or all aspects of the player. Other dynamic resizing methods, instead of dragging the borders or intersections of windows may also be implemented. For example, clicking certain regions of the player to resize or reconfigure, keyboard combinations, and eyeball-tracking. In other aspects of the invention, the display resizing or reconfiguration may be initiated by a trigger, such as timers or other ongoing actions and events, like fluctuation in stock prices.

A practical usage for users would be to view videos and/or audios recorded from one or more devices and perspective views of an event. In a non-limiting example, multiple views of an instructional video for learning to play drums may be presented in multiple windows on the display screen of a network capable device. Each video presented in the plurality of windows may show various views of the drummer's limbs—each of the hands and feet respectively. Observing the videos presented, the user may rearrange the size of each window to present more detail or less detail, start and stop the windows in a synchronized manner, thus permitting the user to learn how to play the drums by following each of the videos separately or in any configuration. The user may rewind and replay, going back and forth in timeline to view each of the videos and see how they all work simultaneously. Additionally, the user may select a speed control that permits the user to slow or speed up the replay to permit better understanding of the content provided in the display window. The speed control may be implemented as a control bar, slider, series of select buttons, or any other selection device to move the playback speed to a different speed at the action of the user, where the playback speed will be modified for all display windows to maintain the synchronization of replay in all display windows.

In another non-limiting example, the celebration of a life event may be another application of the invention. Many guests record videos of wedding or birthday events. Users may play them all on a single display by watching different views presented in a plurality of windows. Users may use the software to view cause and effect when they cannot see two actions at the same time. In a non-limiting example, seeing how moving a lever to different degrees in one room affects a mechanism in another room or across different geographical regions may be possible through the synchronized replay of a plurality of video files in two or more windows on the display screen.

In an additional embodiment, the invention may find broad application in education and training of skills (fine motor, physical, or hands-on skills) such as performing on musical instruments, performance arts, crafts, sports, fitness, engineering, medical care, or even activities such as the solution to the Rubik's cube. The system may also find application in demonstrating how physical equipment or hardware products work, for example a forklift, or operating a manual transmission. In an embodiment, a user may be presented with multiple views of a video recorded entertainment. The system may provide for showing various camera angles of an event, and permit the user to select the view in which they are interested, rather than that selected by a producer or director of an event broadcast.

In an embodiment, the invention is readily utilized within the security field to analyze various recorded feeds after an event on a single display. As indicated previously, the present invention is also applicable as a media player for computers, smartphones, tablets, and wearable device technologies.

In an embodiment, a system and method for presenting multiple media content views is presented. The system may be implemented on an electronic device having a processor, an electronic storage device, a display screen, and network communication connectivity. The system and method may receive and store one or more media content files for display on a display screen associated with any mobile device having a network communication capability. The system may select media content files for presentation to a user, and present the selected media content files on the display screen in two or more preconfigured video display windows. Additionally, the one or more video display windows may be resized on the display screen based upon a control input from the user, while synchronizing the media content presented in each of the video display windows.

In an embodiment, the system and method may have one or more control points permitting a user to resize the two or more video display windows by moving the one or more control points to a point on the display screen that is different from the starting point of each control point, as well as rotating the view of the media content in any video display window. The system and method may synchronize the media content files to permit all media content to be displayed at the same relative position within the media content in each video display window such that none of the video display windows overlap any other video display window. In addition, the resizing of the two or more video display windows permits one or more video display windows to occupy a larger percentage of the display screen, and the other video display windows occupy a smaller percentage of the display screen. The user may also select one video display window to be resized to occupy 100% of the available display screen area. The system and method may also present the synchronized media content files in each of the video display windows in such a way that the media content is reconfigured into corresponding sized or dimensioned “units” in relation to a time similar to ‘frames per second’, to permit each media content view to start, pause, stop, and resume at the same relative point within the media content.

In an alternative embodiment, the rotation of the view within a video display window rotates the view around a vertical axis through the center of the video display window to an orientation that is the opposite orientation of the starting view.

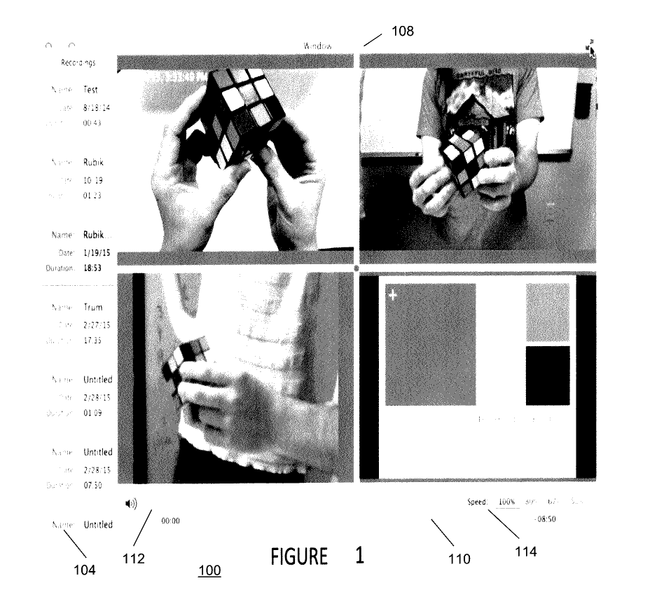

Turning now to FIG. 1, this figure presents a view of a screen displaying four video feeds in four windows consistent with certain embodiments of the present invention. In an exemplary embodiment, a display screen on a network capable device such as a computer, network computer, tablet, smartphone, or wearable device is presented with multiple video display windows configured on the display screen 100. In an exemplary configuration, a control panel 104 may be presented indicating a plurality of video sources from which a user may select to download video and multimedia presentations. The video and multimedia presentations may be composed of video and audio files that may be selected and configured to be displayed in a window on the display screen 100. The video window configuration may be pre-selected by a user to display two or more video and/or multimedia presentations in different windows that are simultaneously active on the display screen 100. The video and/or multimedia presentations may be initiated within windows that display without overlapping one another 108. In an exemplary embodiment, the user may select a video replay of an instructional video that provides four different points of view of performing a task. Each point of view being a separate video presentation, with or without associated audio tracks that are presented in a separate video display window 108. As previously described, each video may be initiated, or played, in a video display window that is synchronized with all other video display windows currently configured on the display screen 100. The video windows do not overlap on the display screen 100, and each video window may be resized to be larger or smaller, that is to occupy a greater or lesser proportion of the area of the video display screen 100, under control of the user. Additionally, the user may select the full-screen display mode to permit the display windows to occupy 100% of the display screen area. The user may scroll through the display windows in full-screen mode, and then select the display screen through a tap or other action to return the view to the pre-configured number of display windows on the video display screen 100.

In a non-limiting example, the initial display of an instructional video to teach the solution of a Rubik's cube puzzle is presented. The user has selected this instructional video from the list presented 104, and the display screen is pre-configured to present four display windows, each of which presents a different viewpoint of an instructor as they present the motions required to solve the puzzle. In this non-limiting example, the four display windows occupy the same amount of the area of the display screen, relative to one another such that no display window overlaps any portion of any other display window. Additionally, the user has access to control sliders for video replay 110 and audio track replay 112, each of which controls the replay point within all configured window displays simultaneously. The control sliders permit the user to start, stop, replay, or pause the video and multimedia replay within all video display windows. Additionally, a speed control 114 may be configured to permit the user to select a different speed for the replay of the video in all pre-configured windows, or in the single display window presented to the user when in full-screen mode. The speed control 114, once selected, will modify the speed of playback for all display windows to retain the synchronization of the playback in all display windows.

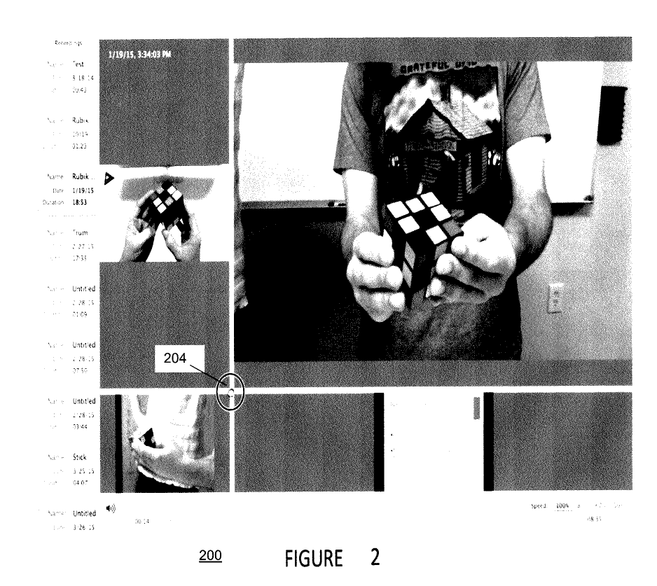

Turning now to FIG. 2, this figure presents a view of a user interface showing a resizing of the window displays and their respective video feeds consistent with certain embodiments of the present invention. In an exemplary embodiment, the system presents a view of a display screen 200 that is configured to display multiple windows for video replay. In this exemplary embodiment, the display screen 200 has been configured to display four display windows, each of which may present to the user a different video or multimedia presentation. As previously described, the display windows are synchronized with regard to the replay of the video or multimedia presentation and do not overlap any other display window presented on the display screen.

In this exemplary embodiment, the user is presented with one or more control points 204 for use in modifying the relative screen display area that is to be occupied by the display windows. The modification of the relative screen display area may permit the user to resize one or more of the display windows to occupy more or less of the screen display area, and permit a corresponding increase or decrease in the screen display area occupied by the other display windows in the configured display. The user may choose to make one or more display windows larger or smaller, or may select a single display window to occupy 100% of the available screen display area. In the configuration where a single display window occupies 100% of the available screen display area, the video and/or multimedia displays associated with the other display windows continues to be tracked and managed such that if the user resizes the single display window to occupy a smaller portion of the available screen display area, the video and/or multimedia presentation in the other display windows remains synchronized with the display window that has decreased to less than 100% sizing. The system transforms the video or multimedia files in such a way that they are broken down into corresponding sized or dimensioned “units” in relation to a time similar to ‘frames per second’ to maintain the synchronization of each display in response to user control actions.

In this exemplary embodiment, the user may use one or more input methods such as mouse, keyboard, and gesture on touch screens or motion gestures to input a control to the system to resize or otherwise control the display windows. In a non-limiting example, the user has selected the control point 204 that may be located as the center point of a four display window configuration. The control point 204 may be relocated on the screen display through the action of a user such that as the control point is moved to a different position on the screen display 200, the display windows are resized to occupy differing portions of the screen display area in response to the user input. During the control action of moving the control point 204 to a different location on the screen display, the video and/or multimedia replay continues in each of the active and visible display windows. In this non-limiting example, additional control points and control sliders may be defined by the system such as at the edge of any display window, at any corner point of any display window, along the sides of any display window, at the top or bottom of the screen display 200, or in any other position on the screen display that is accessible to the control action of a user.

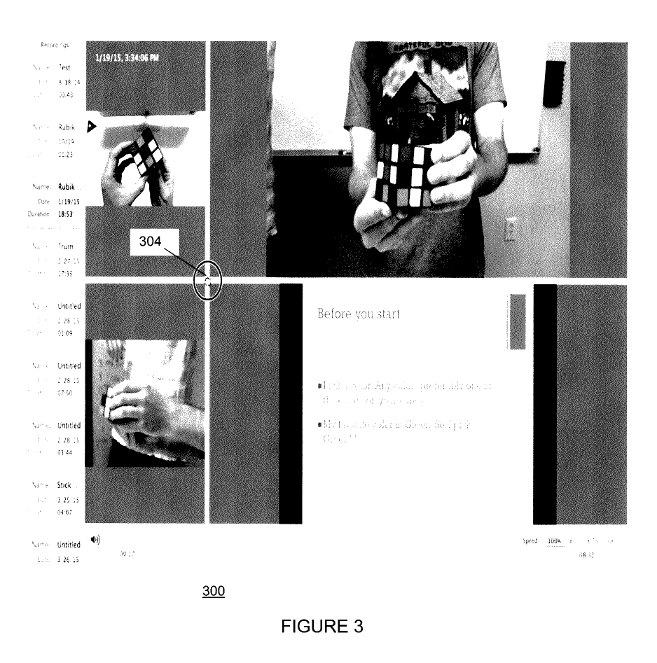

Turning now to FIG. 3, this figure presents a view of a user interface showing a resizing of the four windows and their respective video feeds consistent with certain embodiments of the present invention. In an exemplary embodiment, a screen display 300 having a control point 304 positioned at the center point of a four display window configuration on a screen display 300 is presented. In this non-limiting example, the user has chosen to move the control point 304 to a position on the screen display 300 that permits two of the four display windows to be larger than the remaining two display windows. Once again, user interaction with a control point 304 permits the relative resizing of the display windows such that one or more of the display windows may occupy more or less of the screen display area relative to the other display windows in the screen display 300.

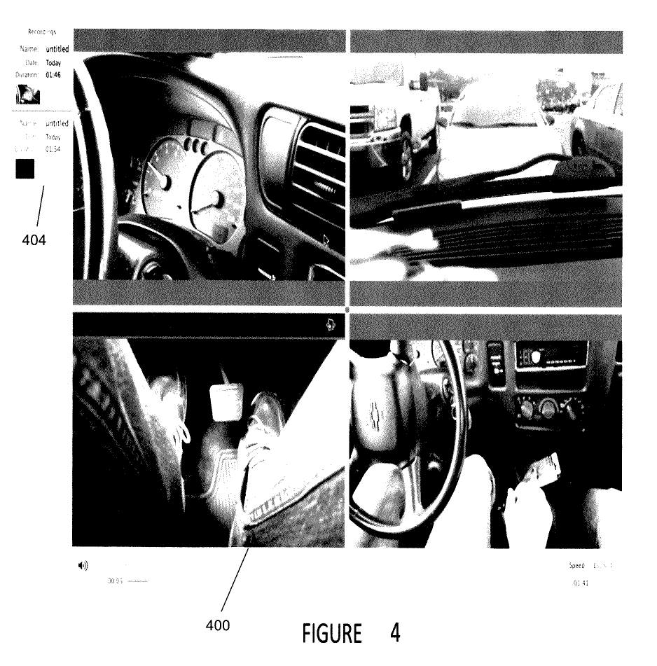

Turning now to FIG. 4, this figure presents a view of a screen displaying four video feeds in four windows consistent with certain embodiments of the present invention. In an exemplary embodiment, the system provides the capability for each video file selected to be assigned for display to one of a plurality of windows 400. The system cycles through video frames of each file and presents them to their respective windows for display, such that each may be displayed at synchronized corresponding points in time.

In this exemplary embodiment, the user may select an instructional video from the available recordings 404 for display in a four window configuration. The user may be presented with four different videos, synchronized with one another, of four different points of view for the instructional video. As the user reviews each of these videos, they receive instruction from multiple points of view of the same process proceeding at the same rate of speed and the same relative position within each video recording simultaneously. In this manner, the user is presented with all instructional actions that are occurring at the same points in time. The system may permit the user to start, stop, pause, resize, resume, replay, or otherwise control the video and/or multimedia presentations in the video windows to assist the user in gaining a complete understanding of the subject being taught.

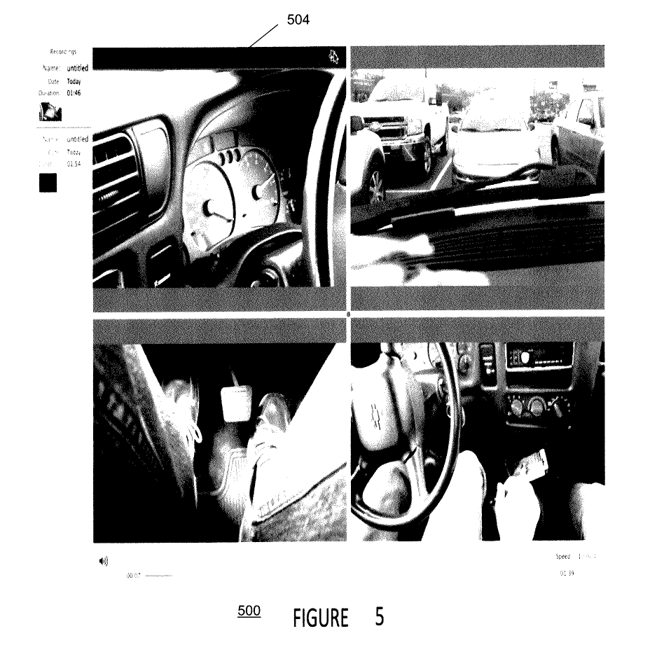

Turning now to FIG. 5, this figure presents a view of user interface showing a flip-screen feature consistent with certain embodiments of the present invention. In this embodiment, the screen display 500 is once again configured in a four display window configuration. In a non-limiting example, the user may desire a point of view that is different from the points of view presented in the pre-configured video displays. In this instance, the user may select one or more of the display windows and further select a rotate function to permit the view of the video on display in the display window to be rotated so as to present a different orientation for the video in the selected display window 504. The user may be presented with an option to rotate the view in the display window 504 such that the orientation of the displayed view is rotated about a vertical axis drawn through the centerline of the display window such that the view is rotated as much as 180 degrees from the original orientation of the view in the display window.

In a non-limiting embodiment, the user may select one, two, or all display windows for the rotate action, and perform an additional rotate action to return the video display to the original orientation in any display window.

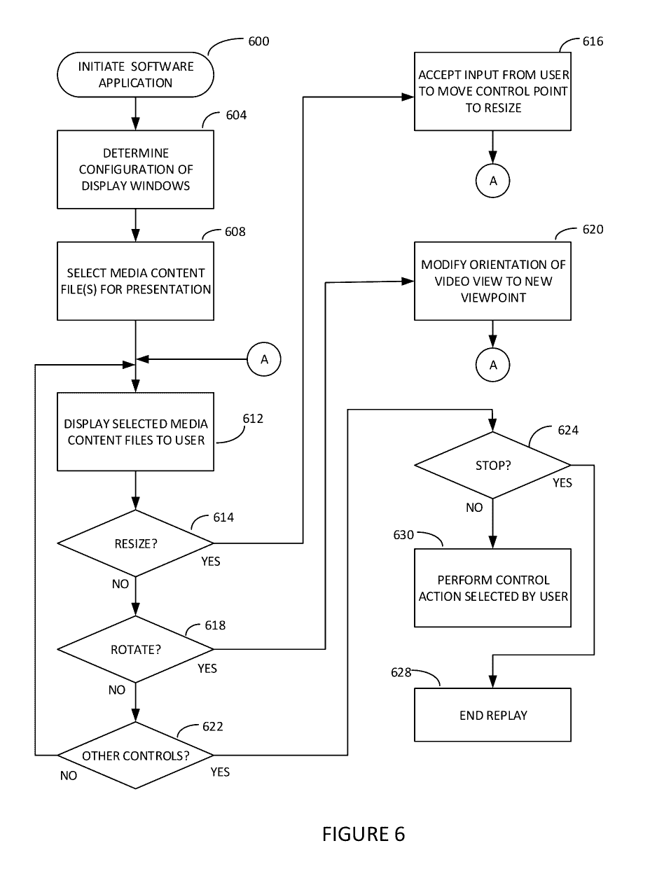

Turning now to FIG. 6, this figure presents a process flow for the operation of the multiple media content viewer consistent with certain embodiments of the present invention. In this exemplary embodiment, at 600 the user may select the process from a screen of software icons to initiate the multiple media content viewer. Upon initiation, at 604, the user may be presented with a default configuration for the number of video display windows that will be presented on the screen display. The user may accept the pre-established configuration or may elect to change the number of video windows that will be presented on the screen display. In a non-limiting example, the pre-configured number of windows may be set to two display windows and the user desires to view a set of four video or multimedia content files. In this non-limiting example, the user may elect to change the preconfigured number of display windows from two to four to accommodate the desire to view additional video content files.

Upon selection of the configuration of display windows, at 608 the user may be presented with a list of video and multimedia content files that are available for replay or view. The user may select from this list, or may request a video or multimedia content file from another source that is available to the system through a server or other internet capable connection. Upon selection the video or multimedia files are imported into the system software. The multiple video or multimedia files are analyzed and converted into corresponding sized or dimensioned “units” in relation to a time similar to ‘frames per second’ to maintain the synchronization of each display in response to user control actions. Upon completion of the conversion and synchronization process, the media content files are presented to the user at 612 on the preconfigured display windows on the display screen, with one media content file assigned to each preconfigured display window. The preconfigured display windows are presented on the display screen in a non-overlapping configuration, and the display windows never overlap one another regardless of the sizing of each display window.

During playback the user may be presented with control options to permit the user greater flexibility in the reviewing of the media content in any or all display windows. At 614, the user may choose to resize one or more of the media content display windows. If the user selects the option to resize, at 616 the user selects a control point on the display screen, as previously described, and moves the control point to a location different from the original position of the control point. The media content display windows are resized in reaction to the movement of the control point, or control points, by the user, providing one or more of the media content display windows with a greater or lesser portion of the display screen based upon the new position of the control point(s). The user may choose to move the control point(s) to a position such that a single media content display window occupies 100% of the display screen area. Upon release of the control point by the user, the media content files may continue the replay of the media content files in each of the visible media content display windows without impacting the synchronization of the video or multimedia content being displayed in each display window.

If the user does not choose to resize one or more of the media content display windows, the user may instead choose to rotate the view of the media content being displayed in any of the media content display windows at 618. If the user selects this control option, the system accepts the input selection of the one or more media content display windows that the user desires to rotate. At 620, the system may then rotate the media content display view around the vertical axis of the media content display window, presenting a media content view that is 180 degrees shifted from the starting display view orientation. The system will then continue the replay of the media content files in each of the media content display windows, with the view in the display windows selected rotated to the new orientation.

If the user does not desire to resize or rotate any of the views within any of the media content display windows, the user may still select options to control the presentation of the media content at 622. If the user desires to stop the replay, at 624 the user may select a stop option to end the replay of the media content. Upon selection of this option, the replay and presentation of the media content will cease and the user may be presented once again with the initial software application display at 628.

If the user instead desires to input another control action, such as pause, replay, rewind, or continue, the system accepts this input from the user at 630. The system is then operative to perform the action indicated by the control selected by the user. The system will perform the control action for each media content video simultaneously so as to maintain synchronization between the media content view displayed in each of the media content display windows. Upon completion of the control action, the system will once again continue to present the media content to the user in each of the visible media content display windows.

While certain illustrative embodiments have been described, it is evident that many alternatives, modifications, permutations and variations will become apparent to those skilled in the art in light of the foregoing description.

1. A system for presenting multiple media content views, comprising:
a electronic device having a processor, an electronic storage device, a display screen, and network communication connectivity;
a software module operable to present video content to the display screen in two or more preconfigured video display windows;
an input capability to accept input from a user to cause any of the preconfigured video display windows to be resized;
a software module operable to synchronize the media content presented in each of the video display windows.

2. The system of claim 1, further comprising one or more control points permitting a user to resize the two or more video display windows by moving the one or more control points to a point on the display screen that is different from the starting point of each control point.

3. The system of claim 1, further comprising a software module operable to accept input from a user to cause a rotation of the media content view in any video display window.

4. The system of claim 1, further comprising a software module operable to manage the synchronization of media content to permit all media content to be displayed at the same relative position within the media content in each video display window.

5. The system of claim 1, where the two or more pre-configured video display windows are presented on the display screen such that none of the video display windows overlap any other video display window.

6. The system of claim 2, where the resizing of the two or more video display windows permits one or more video display windows to occupy a larger percentage of the display screen, and the other video display windows occupy a smaller percentage of the display screen.

7. The system of claim 6, where the video display windows do not overlap at the conclusion of any resizing activity.

8. The system of claim 6, where one video display window is resized to occupy 100% of the available display screen area.

9. The system of claim 3, where the rotation of the view within a video display window rotates the view around a vertical axis through the center of the video display window to an orientation that is the opposite orientation of the starting view.

10. The system of claim 1, where the synchronized media content presented in each of the video display windows is configured in such a way that the media content is reconfigured into corresponding sized or dimensioned “units” in relation to a time similar to ‘frames per second’, to permit each media content view to start, pause, stop, and resume at the same relative point within the media content.

11. A process for presenting multiple media content views, comprising:
receiving and storing one or more media content files for display on a display screen associated with any mobile device having a network communication capability;
selecting media content files for presentation to a user;
presenting the selected media content files on the display screen in two or more preconfigured video display windows;
resizing one or more video display windows on the display screen based upon a control input from the user;
synchronizing the media content presented in each of the video display windows.

12. The system of claim 11, further comprising one or more control points permitting a user to resize the two or more video display windows by moving the one or more control points to a point on the display screen that is different from the starting point of each control point.

13. The system of claim 1, further comprising rotating the view of the media content in any video display window.

14. The system of claim 11, further comprising synchronizing the media content files to permit all media content to be displayed at the same relative position within the media content in each video display window.

15. The system of claim 11, where the two or more preconfigured video display windows are presented on the display screen such that none of the video display windows overlap any other video display window.

16. The system of claim 12, where the resizing of the two or more video display windows permits one or more video display windows to occupy a larger percentage of the display screen, and the other video display windows occupy a smaller percentage of the display screen.

17. The system of claim 16, where the video display windows do not overlap at the conclusion of any resizing activity.

18. The system of claim 16, where one video display window is resized to occupy 100% of the available display screen area.

19. The system of claim 13, where the rotation of the view within a video display window rotates the view around a vertical axis through the center of the video display window to an orientation that is the opposite orientation of the starting view.

20. The system of claim 11, further comprising presenting the synchronized media content files in each of the video display windows in such a way that the media content is reconfigured into corresponding sized or dimensioned “units” in relation to a time similar to ‘frames per second’, to permit each media content view to start, pause, stop, and resume at the same relative point within the media content.
